(19) United States
(12) Patent Application Publication
(10) Pub. No.: US 2015/0089921 A1
(43) Pub. Date: Apr. 2, 2015

(54) AUXILIARY POWER SUPPLY METHOD THROUGH AN AUXILIARY POWER UNIT AND CORRESPONDING ARCHITECTURE

(71) Applicant: Microturbo, (US)

(72) Inventors: Jean-Francois Rideau, Tournefeuille (FR); Fabien Silet, Pechbonnieu (FR)

(73) Assignee: MICROTURBO, Toulouse (FR)

(21) Appl. No.: 13/845,862

(22) Filed: Mar. 18, 2013

(30) Foreign Application Priority Data
May 10, 2012 (FR) 1254249

(51) Int. Cl. F02C 9/46

(52) U.S. Cl. CPC F02C 9/46
USPC 60/39.091

(57) ABSTRACT

An auxiliary power supply architecture includes one APU and a fuel supply basic circuit with a common fuel storage tank, a primary circulation conduct and secondary conducts for injecting such fuel into the combustion chambers of the APU unit through appropriate injectors. Such architecture also includes another independent fuel supply circuit to supply the APU unit with an emergency tank, a specific primary conduct for emergency fuel circulation and secondary conducts for injecting emergency fuel into the combustion chambers through appropriate injectors.

### TECHNICAL FIELD

The invention relates to an auxiliary power supply method for aircrafts through an auxiliary power unit, in short APU (“Auxiliary Power Unit”), as well as auxiliary supply power architecture therefor.

The invention applies to aircraft engines, i.e. not only to airplane engines (turbojets, turboprops), but also to helicopter turbo-engines as well as to non propulsive power generators.

The aircrafts are equipped with main engines dedicated to propulsion and, at a cruising speed, to non propulsive power generation (air conditioning, cabin air pressurization, electrical current, etc.). The APU unit is a small turbo-generator or auxiliary engine that supplies non propulsive power on ground or in flight, when the main engines are not able to supply non propulsive power any more: for example, in the case when the flight conditions become difficult or for delicate phases in particular missions (search, unfriendly environment, etc.) or in the case of a loss of one or more generators integrated into the main engines.

The aircraft is also equipped with another auxiliary emergency power source for specific systems, in an extreme emergency case: it is a small wind turbine or a small turbine (a so-called RAT or “Ram Air Turbine”) that is extended externally to supply power by coupling with a hydraulic pump or an alternator. The RAT generates necessary power for the vital systems of the aircraft (flight controls, associated hydraulic circuits and critical flight instruments).

### STATE OF THE ART

Generally, the main engines of the aircraft are operational, and the APU as well as the RAT are not used in flight and thus represent loads. Moreover, the RAT must meet strong maintenance constraints.

So as to take profit from at least in part the presence of the APU unit, solutions have been proposed to use such equipment as a non propulsive power source upon the flight. Patent applications have been filed in that way by the present Applicant, for example the application published under number FR 2,964,086.

The use of a RAT allows the rule requirements to be met in terms of emergency power source. However, such equipment is not useful in the standard flight conditions or at ground level.

The main disadvantages of known equipment lie in the unnecessary flight load of such equipment and in the strong maintenance constraints, in particular for the RAT.

### DISCLOSURE OF THE INVENTION

The invention aims at compensating for such disadvantages by withdrawing the RAT, proposing also to dedicate the APU unit for emergency power supply instead of the RAT. So that the APU unit can fully secure its emergency equipment function, it is envisaged that such APU is protected from the main cause of common failure with the engines—namely contamination by fuel—by setting a specific fuel supply.

More precisely, the present invention aims at providing an auxiliary power supply method for an aircraft, being equipped with main engines and power consumers, through an auxiliary APU type power supply unit, wherein the APU unit is used in a primary mode to supply non propulsive power to consumers of the aircraft from a fuel source being common to the engines of the aircraft and to the APU unit, being followed by a basic circulation of such common fuel up to the APU unit. In such method, the APU unit is also used in an emergency mode so as to bring emergency power to the vital systems of the aircraft. The APU unit is then supplied with emergency fuel from a specific source according to an independent circulation being separated, at least in one part connected with the specific source, from the basic circulation.

Preferably, the emergency fuel is of a different nature from the common fuel. Moreover, in case of a power supply in an emergency mode, the emergency fuel can be injected—for the combustion thereof in the APU unit—separately from the common fuel injection in the primary mode.

More particularly, the common fuel—used in the primary mode—being kerosene, the emergency fuel—used in an emergency mode—may be hydrogen. The hydrogen is either directly stocked in the solid, liquid or gaseous state within the specific source, or produced through an appropriate refining of kerosene being stocked within such specific source.

Advantageously, hydrogen stocking is carried out under a solid form being particularly stable and allows a quasi instantaneous state change under liquid or gaseous form through a pyrotechnical firing.

Upon failure detection, the emergency mode is triggered by a centralized command that releases the emergency fuel, drains the fuel circulations, adjusts the specific fuel flow rate and, the case being, switches the independent circulation into the basic circulation and leads to APU firing.

The invention also relates to auxiliary power supply architecture for an aircraft being able to implement the above-mentioned method. Such architecture comprises an APU unit and a fuel supply basic circuit, comprising a common fuel storage tank for the whole aircraft propulsion including the APU unit, a primary circulation conduct for the common fuel and secondary conducts for injecting such fuel into combustion chambers of the APU unit through appropriate injectors. Said architecture also comprises another fuel supply circuit for the APU unit. Such independent circuit comprises an emergency tank, a specific primary conduct for emergency fuel circulation and secondary conducts for injecting emergency fuel into the combustion chambers of the APU unit through appropriate injectors.

According to preferred embodiments:
the emergency fuel being hydrogen, the specific primary circuit can comprise a refining arrangement for converting kerosene being stocked in the tank into hydrogen via a reformer;
the fuel injection secondary conducts for the basic circuit and the independent circuit are either distinct with injectors dedicated to common fuel and other injectors dedicated to the emergency fuel, or grouped together so that, the primary and the secondary conducts being respectively mounted upstream and downstream from a switching valve, the secondary conducts circulate the common fuel or the emergency fuel up to the injectors being common to the fuels;
the emergency tank, comprising one storage part for hydrogen in a solid state and one buffer storage part for hydrogen in a liquid state, is associated with a pyrotechnical generator as well as a control valve mounted on the primary conduct on a hydrogen gas output;
the architecture also comprises an electronic command emergency unit piloting the hydrogen flow rate control valve, the pyrotechnical generator as well as the APU unit based on information as regards valve opening and pressure at the APU level; and
a strong pressure draining system piloted by the electronic command unit is provided for draining circuit residues.

### BRIEF DESCRIPTION OF DRAWINGS

Other aspects, characteristics and advantages of the invention will appear in the non limitative following description, relative to particular exemplary embodiments, referring to the accompanying drawings wherein, respectively:

FIG. 1 shows the schema of an exemplary architecture according to the invention comprising an independent hydrogen supply circuit for emergency fuel stored in a tank;

FIG. 2 shows the schema of another exemplary architecture according to the invention comprising an independent hydrogen supply circuit provided by kerosene being refined, the independent and basic circuits being grouped together to inject fuel via a switching valve, and

FIG. 3 shows the schema of another exemplary architecture according to the invention, comprising an independent hydrogen supply circuit for solid hydrogen as an emergency fuel stored in a tank and a command and control means for the independent circuit.

### DETAILED DESCRIPTION OF EMBODIMENTS

In the present specification, the terms “upstream” and “downstream” are related to locations depending on the fuel circulation direction. Identical annotations on different figures relate to the same members defined in the corresponding passages of the description.

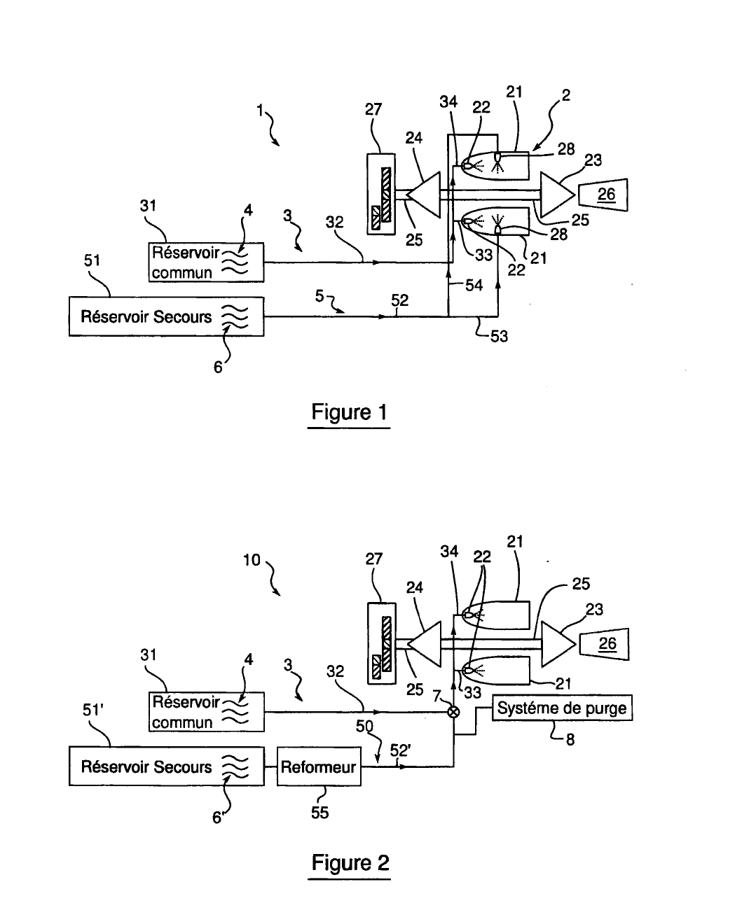

Referring to the schema of FIG. 1, the exemplary architecture 1 for supplying auxiliary power to an aircraft comprises an APU unit 2 and a basic circuit 3 for supplying fuel 4 within the APU unit 2. Such circuit comprises a fuel storage tank 31, namely kerosene in the example, for a common supply to the engines of the aircraft (not shown) and the APU unit 2. It also comprises a primary conduct 32 for common fuel circulation, and secondary conducts 33, 34 for injecting such fuel 4 into the combustion chambers 21 of the APU unit 2. Such injections are carried out by injectors 22.

The APU unit 2 comprises a gas generator consisting in a driving turbine 23 for an air compressor 24 through a transmission shaft 25 and a gas ejection nozzle 26. On the transmission shaft 25, an accessory box 27 is mounted, that then transmits mechanical power to the power consumers (cabin air conditioning, pressurization, electrical network, hydraulic circuit, flight control systems, etc.) via appropriate pumps and alternators (not shown).

In the primary mode, non propulsive power is supplied to the consumers of the aircraft by a fuel supply from a common tank 31 not only at ground, which is the main function of an APU, but also in flight—during any or all the flight phases—in addition or instead of the engines.

The architecture 1 also comprises an independent supply circuit 5 for the APU unit 2, such circuit being totally separated from the basic circuit 3 in this example. Such independent circuit 5 comprises an emergency tank 51 for the storage of the emergency fuel 6—hydrogen in the example—, a specific primary conduct 52 for emergency fuel circulation, and secondary conducts 53 and 54 for injecting emergency fuel 6 into the combustion chambers 21 of the APU unit 2.

The conducts 52 to 54 form a specific ramp calibrated for hydrogen. The injectors 28 for the emergency fuel 6 via the secondary conducts 53 and 54 are also specific, i.e. dedicated to the emergency fuel 6. But they can be identical in their structure when the emergency fuel 6 is of the same nature as the common fuel 4, for example kerosene. A dedicated firing system can be associated with the specific ramp. However, as far as possible, the use of the main firing system is privileged.

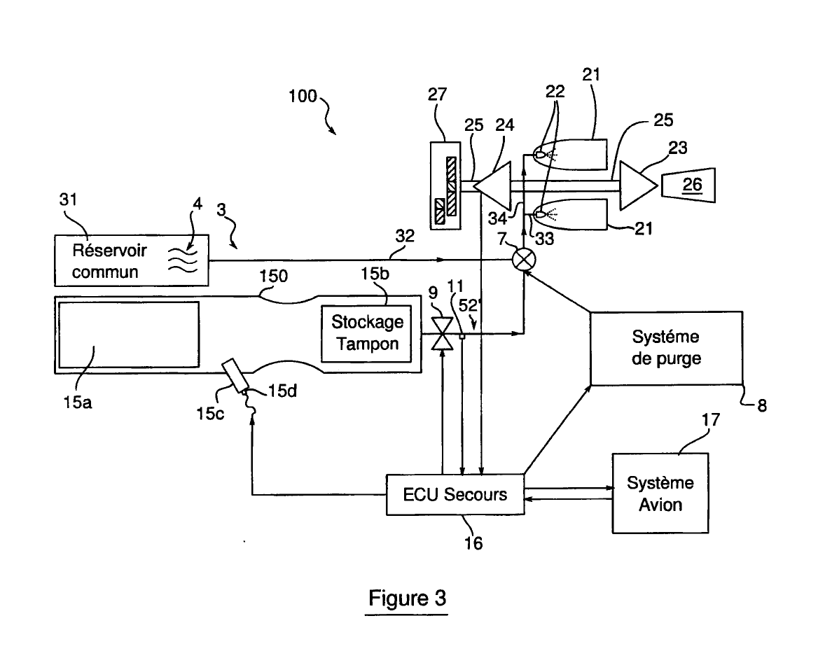

Hydrogen storage can be made under solid, liquid and gaseous form. Advantageously, storage under a solid form presents a great stability as well as a quasi instantaneous implementation rapidity, for example with a pyrotechnical generator (see the exemplary architecture referring to FIG. 3). In addition, such generator simplifies the maintenance operations and enables then to gain time.

In an emergency mode, the independent circuit 5 is requested to supply a specific fuel 6—neither contaminated nor contaminable by the common fuel 4—to the vital systems (control systems, instruments, etc.) in connection with the accessory box 27.

Another exemplary architecture according to the invention is illustrated by the schema of FIG. 2. In such architecture 10, the same basic circuit 3 is integrated with its common tank 31, its primary 32 and secondary 33, 34 conducts and the injectors 22 thereof.

The independent circuit 50 comprises an emergency tank 51′ and a specific primary conduct 52′ for emergency fuel circulation. The tank 51′ and the conduct 52′ have the same functions as the tank 51 and the conduct 52 of preceding example. The tank 51′ stores kerosene 6′ and an arrangement 55 for refining kerosene into hydrogen via a catalytic reformer is integrated into the primary circuit 52′. Such a catalytic reforming is for example described in the patent document WO 2009/040112.

In the present example, the two basic 3 and independent 50 circuits are partially separated: such circuits mutualize in fact their secondary conducts, for example by taking over the conducts 33 and 34 of the basic circuit (or the secondary conducts of the independent circuit) through the downstream mounting of such conducts on a switching valve 7. Such valve enables to switch between a supply in a common fuel, kerosene, and in an emergency fuel, hydrogen for example. According to the position command transmitted to the valve 7, the secondary conducts inject then the kerosene from the basic circuit 3 or the hydrogen from the independent circuit 50 into the combustion chambers 21.

Such command depends on the failure or emergency situation detections for determining the operation mode: the primary mode or the emergency mode. An exemplary mode command as a function of the detections will be farther described.

In order to supply the secondary conducts with kerosene or hydrogen, according to the operation mode, the primary conducts 32 and 52′ of the basic 3 and independent 50 circuits are coupled upstream on the switching valve 7.

Moreover, a draining system 8 is advantageously added for the good operation of the circuits. Such draining system can be either high pressure air, or a high pressure chemical solution.

A third exemplary architecture according to the invention is illustrated by the schema of FIG. 3. Such architecture 100 comprises an independent circuit 15 for a solid hydrogen supply as an emergency fuel—of the type previously described referring to FIG. 2—with a primary conduct 52′ and secondary conducts in common with those of the basic circuit 3, such as previously described referring to FIG. 2.

Hydrogen is stored in an emergency tank 150 that comprises one storage part 15a for hydrogen in the solid state and one buffer storage part 15b for hydrogen in the gaseous state. The presence of such buffer area guarantees one pressurization level. A pyrotechnical gas generator 15c, that comprises a cartridge 15d for firing a propergol block, is coupled with the tank 150. On the output of the tank 150, a control valve 9 is mounted on the primary conduct 52′.

The primary conducts 32 and 52′, respectively, of the basic 3 and independent 150 circuits are mounted upstream on the switching valve 7 as in the configuration of FIG. 2. Such valve is for example a fast dynamics electromechanical valve or an electromechanical or pyrotechnical triggering guillotine valve. In the same way, the mutualized secondary conducts 33 and 34 are mounted downstream from the valve 7 to supply the injectors 22. The independent circuit 150 is thus only separated from the basic circuit 3 within its primary part, which stays essential to preserve the non contamination of the emergency fuel.

The architecture 100 also comprises an emergency electronic command unit 16, in short ECU (for “Electronic Control Unit) that pilots the hydrogen flow rate control valve 9, the pyrotechnical generator 15c as well as the possible firing of the APU unit 2. Such piloting is carried out on the base of opening information of the valve 9 supplied by a sensor 11 and pressure information at the level of the compressor 24 of the APU unit 2. The command unit 16 also communicates with the piloting center 17, the so-called aircraft system. The emergency ECU can be a unit being redundant with respect to the main ECU of the aircraft, or a particular card of the main ECU dedicated to the emergency function with a specific supply device.

As in the previous example, a strong pressure draining system 8 is piloted by the emergency ECU unit 16 to drain the residues that have a good chance to filling up the circuits. Such system is for example based on a high pressure pressurization system generated either by a bottle with air compressed at 300 bar, or an inert gas generator at 700 bar. The triggering thereof may be done by a device being identical to the solid hydrogen generation one.

Upon failure detection, for example an electrical supply failure, the aircraft system 17 transmits a switching order in an emergency mode to the emergency ECU 16. The switch to an emergency mode is carried out according to the present procedure for triggering the RAT. The ECU 16 then triggers the firing of the pyrotechnical cartridge 15d for hydrogen generation and the draining system 8, transmits the switching command to the valve 7, pilots the hydrogen control valve 9 to adjust the hydrogen flow rate, as well as the rotating operation and the firing of the APU 2. The piloting of the APU 2 in an emergency mode is made via the ECU 16.

The invention is not limited to the examples being described and represented.

It is for example possible to combine any of the emergency fuel sources being above described with any of the fuel injection configurations in the combustion chambers of the APU unit as above explained.

Furthermore, the injection means can be combined with mixing means for two distinct fuels, a command fuel and an emergency fuel. The switching or controlling valves can be substituted by any equivalent flow rate selection or adjustment means.

### EMBODIMENTS

1. An auxiliary power supply method for an aircraft, being equipped with main engines and power consumers, through an auxiliary APU type power supply unit, provided with a combustion chamber, wherein the APU unit is used in a primary mode to supply non propulsive power to consumers of the aircraft from a source of fuel being common to the engines of the aircraft and to the APU unit, being followed by a basic circulation of such common fuel up to the combustion chamber of the APU unit, characterized in that the APU unit is also used in an emergency mode so as to bring emergency power to the vital systems of the aircraft, the combustion chamber of the APU unit being then supplied with emergency fuel from a specific source according to an independent circulation being separated, at least in one part connected with the specific source, from the basic circulation.

2. The supply method according to the preceding embodiment, wherein, in case of a power supply in an emergency mode, the emergency fuel can be injected—for the combustion thereof in the APU unit—separately from the common fuel injection in the primary mode.

3. The supply method according to embodiment 1, wherein, the common fuel being kerosene, the emergency fuel is hydrogen being directly stocked in the solid, liquid or gaseous state within the specific source.

4. The supply method according to embodiment 3, wherein the hydrogen is produced with an appropriate refining of kerosene being stocked within the specific source.

5. The supply method according to embodiment 1, wherein, upon failure detection, the emergency mode is triggered by a centralized command that releases the emergency fuel, drains the fuel circulations, controls the specific fuel flow rate and, the case being, switches the independent circulation into the basic circulation and leads to APU firing.

6. A power supply architecture for implementing the method according to the above embodiments, comprising an APU unit and a fuel supply basic circuit, comprising a common fuel storage tank for the aircraft propulsion assembly including the APU unit, a primary circulation conduct for the common fuel and secondary conducts for injecting such fuel into the combustion chamber of the APU unit through appropriate injectors, such architecture being characterized in that it also comprises another fuel supply circuit to supply the APU unit with fuel, such independent circuit comprising an emergency tank a specific primary conduct for emergency fuel circulation and secondary conducts for injecting emergency fuel into the combustion chamber of the APU unit through appropriate injectors.

7. The power supply architecture according to the preceding embodiment, wherein, the emergency fuel being hydrogen, the specific primary circuit comprises a refining arrangement for converting kerosene being stocked in the tank into hydrogen via a reformer.

8. The power supply architecture according to embodiment 6, wherein the fuel injection secondary conducts for the basic circuit and the independent circuit are distinct, with injectors being dedicated to the common fuel and other injectors dedicated to the emergency fuel.

9. The power supply architecture according to embodiment 6, wherein the fuel injection secondary conducts for the basic circuit and the independent circuit are grouped together so that, the primary and secondary conducts being respectively mounted upstream and downstream from a switching valve, the secondary conducts circulate the common fuel or the emergency fuel up to the injectors being common to such fuels.

10. The power supply architecture according to embodiment 8, wherein the emergency tank, comprises one storage part for hydrogen in a solid state and one buffer storage part for hydrogen in a liquid state and is associated with a pyrotechnical generator as well as to a control valve mounted on the primary conduct on a hydrogen gas output.

11. The power supply architecture according to embodiment 6, wherein the architecture also comprises an emergency electronic command unit piloting the hydrogen flow rate control valve, the pyrotechnical generator as well as the APU unit based on information as regards valve opening and pressure at the APU level.

12. The power supply architecture according to embodiment 6, wherein a strong pressure draining system piloted by the electronic command unit is provided for draining circuit residues.

1. An auxiliary power supply method for an aircraft, being equipped with main engines and power consumers, through an auxiliary power supply unit (APU), provided with a combustion chamber, said method comprising:
in a primary mode, supplying non propulsive power with said APU to consumers of the aircraft from a source of a common fuel being common to the engines of the aircraft and to the APU,
performing a basic circulation of said common fuel up to the combustion chamber of the APU,
in an emergency mode, providing emergency power to vital systems of the aircraft with said APU, and
supplying the combustion chamber of the APU unit with emergency fuel from a specific source according to an independent circulation being separated, at least in one part connected with the specific source, from the basic circulation.

2. The supply method according to claim 1, further comprising, in an emergency mode, injecting the emergency fuel for combustion in the APU separately from injecting the common fuel in the primary mode.

3. The supply method according to claim 1, wherein, the common fuel being kerosene, the emergency fuel is hydrogen being directly stocked in a solid, liquid or gaseous state within the specific source.

4. The supply method according to claim 3, further comprising producing the hydrogen with an appropriate refining of kerosene being stocked within the specific source.

5. The supply method according to claim 1, wherein, upon failure detection, the emergency mode is triggered by a centralized command that releases the emergency fuel, drains fuel circulations, controls a specific fuel flow rate, and switches the independent circulation into the basic circulation and leads to firing of the APU.

6. A power supply architecture for supplying auxiliary power, comprising:
an auxiliary power supply unit (APU),
a fuel supply basic circuit, wherein said fuel supply basic circuit comprises a common fuel storage tank for an aircraft propulsion assembly including the APU, a primary circulation conduct for a common fuel and secondary conducts for injecting said common fuel into a combustion chamber of the APU through appropriate injectors, and
an independent fuel supply circuit to supply the APU with fuel, said independent fuel supply circuit comprising an emergency tank, a specific primary conduct for emergency fuel circulation and secondary conducts for injecting emergency fuel into the combustion chamber of the APU through appropriate injectors.

7. The power supply architecture according to claim 6, wherein, the emergency fuel is hydrogen, the specific primary circuit comprises a refining arrangement for converting kerosene being stocked in the tank into hydrogen via a reformer.

8. The power supply architecture according to claim 6, wherein the fuel injection secondary conducts for the basic circuit and the independent circuit are distinct, with injectors being dedicated to the common fuel and other injectors dedicated to the emergency fuel.

9. The power supply architecture according to claim 6, wherein the fuel injection secondary conducts for the basic circuit and the independent circuit are grouped together so that, the primary and secondary conducts being respectively mounted upstream and downstream from a switching valve, the secondary conducts circulate the common fuel or the emergency fuel up to the injectors being common to such fuels.

10. The power supply architecture according to claim 8, wherein the emergency tank comprises one storage part for hydrogen in a solid state and one buffer storage part for hydrogen in a liquid state and is associated with a pyrotechnical generator as well as to a control valve mounted on the primary conduct on a hydrogen gas output.

11. The power supply architecture according to claim 6, further comprising an emergency electronic command unit piloting a hydrogen flow rate control valve, a pyrotechnical generator as well as the APU based on information regarding valve opening and pressure at the APU level.

12. The power supply architecture according to claim 6, wherein a strong pressure draining system piloted by the electronic command unit is provided for draining circuit residues.
